(19) United States
(12) Patent Application Publication
(10) Pub. No.: US 2025/0093156 A1
(43) Pub. Date: Mar. 20, 2025

(54) SENSOR SYSTEM WITH A MEMS GYROSCOPE AND METHOD FOR OPERATING A SENSOR SYSTEM WITH A MEMS GYROSCOPE

(71) Applicant: Robert Bosch GmbH, Stuttgart (DE)

(72) Inventors: Filippo David, Milano (IT); Gabriele Cazzaniga, Rosate Ml (IT)

(21) Appl. No.: 18/827,921

(22) Filed: Sep. 9, 2024

(30) Foreign Application Priority Data
Sep. 19, 2023 (DE) 10 2023 209 063.5

(51) Int. Cl. G01C 19/5712

(52) U.S. Cl. CPC G01C 19/5712

(57) ABSTRACT

A sensor system with a MEMS gyroscope. The sensor system includes: a drive circuit configured for generating an analog drive signal for driving an oscillatable seismic element of the MEMS gyroscope and including a first interface amplifier of a drive detection circuit which is configured such that, due to a movement of the oscillatable seismic element in a drive direction, a first analog signal is detected and is supplied to an input of the first interface amplifier; a detection circuit, coupled to the drive circuit and the oscillatable seismic element and including a second interface amplifier, and being configured such that, due to a movement of the oscillatable seismic element in a detection direction, a second analog signal is detected and supplied to an input of the second interface amplifier, wherein the second analog signal includes an analog rotation rate signal component and an analog quadrature signal component.

### CROSS REFERENCE

The present application claims the benefit under 35 U.S.C. § 119 of German Patent Application No. DE 10 2023 209 063.5 filed on Sep. 19, 2023, which is expressly incorporated herein by reference in its entirety.

### FIELD

The present invention is based on a sensor system with a MEMS gyroscope.

### BACKGROUND INFORMATION

Sensor systems with a MEMS gyroscope are generally operated by means of a drive circuit for generating an oscillation of a seismic element and a detection circuit for reading or detecting an oscillation perpendicular to the drive direction. In addition to the drive circuit, a drive detection circuit is often also present in order to also detect the oscillation in the drive direction. In most cases, due to various elements within the signal processing chain, both for the detected first analog signal of the drive detection circuit and for the detected second analog signal of the detection circuit, a phase shift of the respective signal occurs. This phase shift can be attributed to two main error sources, on the one hand defects within the processed MEMS structure and on the other hand defects within an ASIC structure connected to the MEMS.

The related art provides that such phase shifts or phase differences are not measured directly, but that they are only compensated by an estimated offset value. This, for example, does not allow the temperature operating range of the sensor system with a MEMS gyroscope to be predicted accurately.

Inevitably, this methodology also does not allow any quality assurance of the functionality of the sensor system both during production and during operation of the sensor system.

In addition, the compensation of unwanted signal components of the first analog signal and/or second analog signal represents a further challenge.

MEMS gyroscope sensors generally consist of a drive part, which generates an oscillation (drive movement) of a testing mass, and a detection part, which recognizes the movement of the testing mass due to the angular velocity.

An extremely important parameter of the system is the phase delay of the drive signal path and of the measurement signal path, since they create an offset on the output signal in the case of a disturbing quadrature signal.

The phase delays are partially due to the MEMS and partially due to the ASIC subcomponent.

Normally, such phases are not measured directly in gyroscopes, but only the resulting offset is compensated. The performances of the device in the temperature range cannot be accurately predicted with this method. Moreover, this method does not allow parts with abnormal values, which lowers the quality level in production, to be eliminated.

### SUMMARY

It is an object of the present invention to provide a sensor system with a MEMS gyroscope, which has a structure for the efficient and effective detection or evaluation of phase differences of signals to be processed within the sensor system and additionally compensates for components to be compensated within the signals to be processed.

The present invention provides a function that makes it possible to measure the phase delays of driver channels and readout channels on the ASIC signal paths.

Such phase delays are important factors for the performance of the device. The ability to measure them allows to compensate for their effects on the output signal and thus to improve the performance of the device.

In addition, their measurement provides a method for eliminating abnormal parts in the production of components of the sensor system during testing, and thus to improve the overall quality of the components.

The sensor system according to the present invention according may have an advantage over the related art that the digital test signal is made available in order to detect or measure the phase difference at the first interface amplifier and/or at the second interface amplifier. According to an example embodiment of the present invention, this (initial) digital test signal is converted into the analog test signal via a digital-to-analog converter and fed into the detection device and into the drive detection device by means of the first switch-capacitance structure and the second switch-capacitance structure, or the first analog test signal and the second analog test signal are applied to the devices by means of the first switch-capacitance structure and the second switch-capacitance structure.

Specifically, according to an example embodiment of the present invention, different phases can be measured at the output of the first interface amplifier (with respect to the first analog test signal) and at the output of the second interface amplifier (with respect to the second analog test signal), and it is thus also possible to detect phase differences that result in each case from or due to the respectively traversed signal paths. Such phase differences can provide information about the function or about introduced disturbing signal components of elements within the signal processing chain and/or the MEMS structure and/or an ASIC structure connected thereto. At least one of the first or second analog test signals used or applied to the signal paths can have different amplitudes (or different amplitudes for different applications) and can be used for different configurations of the MEMS structure and ASIC structure or for different operating states of the signal paths used. Such a detection of the resulting different phase differences, or the different phase differences introduced by the signal paths, can take place according to the present invention at the most diverse times: On the one hand, this is possible during the production of the sensor system or its components; on the other hand, this is possible during a test operating mode during the (operative) operation of the sensor or during a start-up or transient process of the sensor system, likewise during the (operative) operation of the sensor; furthermore, it is also possible to carry this out as needed or due to the occurrence of a condition or else continuously.

Furthermore, by means of the quadrature compensation circuit connected to the drive detection circuit and the detection circuit, the quadrature signal component within the second analog signal can be compensated extremely efficiently by applying a compensation signal. In addition, suitable operation in the corresponding temperature range can thus also be ensured.

In particular, it is provided according to an example embodiment of the present invention that a circuit generates and feeds the same analog test signal (or identical first and second analog test signals) into the input of both the drive channel (or drive signal path) and the readout channel (or readout signal path). Such a test signal is processed by the signal paths and, at their output, generates a signal component that can be used to obtain information about the phase delay of the drive channel and the readout channel.

Such a signal can be activated with different amplitudes and with different configurations of the signal chains in order to also measure the phase delay of sub-blocks of the system.

The proposed measurement of the phase delay can take place during testing and/or during commissioning and/or as needed and/or depending on a condition and/or continuously.

Advantageous embodiments and developments of the present invention can be found in the disclosure herein.

According to an advantageous embodiment of the present invention, it is provided that the first switch-capacitance structure has a first variable capacitance for adjusting the application of the first analog test signal and the second switch-capacitance structure has a second variable capacitance for adjusting the application of the second analog test signal. Thus, it is advantageously possible that specially generated test signals for the detection circuit and/or the drive circuit can be fed into the first and/or second interface amplifier. This makes it possible to examine the structure of each circuit in much more detail.

According to an advantageous embodiment of the present invention, it is provided that the first switch-capacitance structure has a first switch for interrupting the application of the first analog test signal and the second switch-capacitance structure has a second switch for interrupting the application of the second analog test signal. This advantageously results in a targeted and thus efficient application of the first or second analog test signal to the first or the second interface amplifier. In particular, the first and/or second switch makes it possible to use the first analog test signal and/or the second analog test signal selectively at the input of the respective interface amplifier.

According to an advantageous embodiment of the present invention, it is provided that the analog test signal is a periodic signal, particularly preferably a sine signal. This advantageously makes it possible to compare the phases of two signals or test signals by means of a phase difference in a particularly efficient and effective manner.

According to an advantageous embodiment of the present invention, it is provided that the digital test generator circuit is configured such that the digital test signal is generated by means of a generation element, in particular comprising a second-order Butterworth filter, and/or is derived from the drive detection circuit by means of a suitable structure, in particular derived from an internal time signal which is regulated to the output of the drive detection circuit. It is thus advantageously possible to ensure, on the one hand, the most effective possible provision of a usable test signal by means of the derivation from the drive detection circuit and, on the other hand, the most efficient possible digital generation of the test signal by means of the generation element, in particular by means of a second-order Butterworth filter.

A further object of the present invention is a method for operating a sensor system with an MEMS gyroscope according to the present invention.

The method according to the present invention for operating a sensor system with a MEMS gyroscope proves to be advantageous over the related art in that the quadrature signal component of the second analog signal is efficiently and effectively compensated in the first method step by means of the compensation signal generated by the quadrature compensation circuit. According to an example embodiment of the present invention, in the second method step, the first and second test signals are generated by means of the digital test signal and the application of the converted analog test signal to the first switch-capacitance structure and the second switch-capacitance structure. Thus, the first and second test signals are applied to the detection circuit and the drive detection circuit in an extremely effective and efficient manner. In detail, the first analog test signal is applied to the input of the first interface amplifier and the second analog test signal is applied to the input of the second interface amplifier. The effects of the first and/or the second test signal can be effectively evaluated at the output of the first and second interface amplifiers. In addition, a relationship to the phase delay or phase change within the quadrature compensation circuit can thus be found. Information about the phase delay within the detection circuit and within the drive detection circuit can therefore be effectively obtained. Furthermore, the signal processing structures within the MEMS structure and within the ASIC structure can thus also be investigated with respect to the phase delays occurring there. The detection of the different phases can take place both continuously during operation and as required for test purposes and also provides information about the operation of the sensor system in various temperature ranges.

The present invention uses a circuit for generating and injecting the same signal into the input of drive channels and read channels. Such a signal is processed by the signal paths and generates an output that can be used to obtain information about the phase delay of drive channels and read channels.

Such a signal can be activated with different amplitudes and with different configurations of the signal chains in order to also measure the phase delay of sub-blocks of the system.

The proposed measurement of the phase delay according to the present invention can take place during testing and/or during commissioning and/or as needed and/or depending on a condition and/or continuously.

The advantages and designs that have been described in connection with the embodiments of the sensor system according to the present invention with an MEMS gyroscope can be used for the method for operating a sensor system with an MEMS gyroscope.

Exemplary embodiments of the present invention are illustrated in the figures and explained in more detail in the following description.

### BRIEF DESCRIPTION OF THE DRAWINGS

FIG. 1 shows a schematic representation of a principle circuit diagram of a sensor system with a MEMS gyroscope, with which a test signal is applied to two signal paths.

FIG. 2 shows a schematic representation of a principle circuit diagram of the sensor system with a MEMS gyroscope with a quadrature compensation circuit.

FIG. 3 shows a schematic circuit diagram of the sensor system with a MEMS gyroscope with the quadrature compensation circuit according to an example embodiment of the present invention.

FIG. 4 shows a schematic block circuit diagram of the generation steps within a digital test generator circuit according to an example embodiment of the present invention.

### DETAILED DESCRIPTION OF EXAMPLE EMBODIMENTS

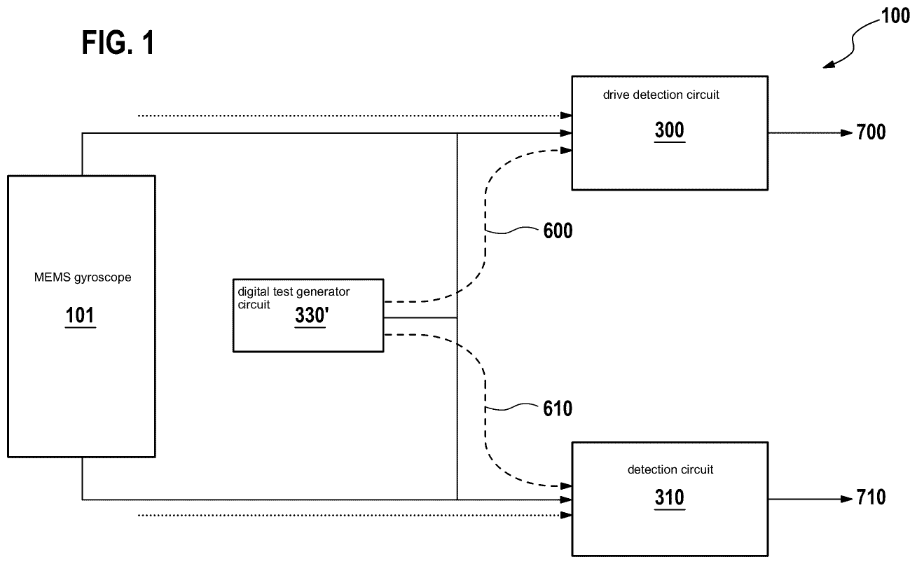

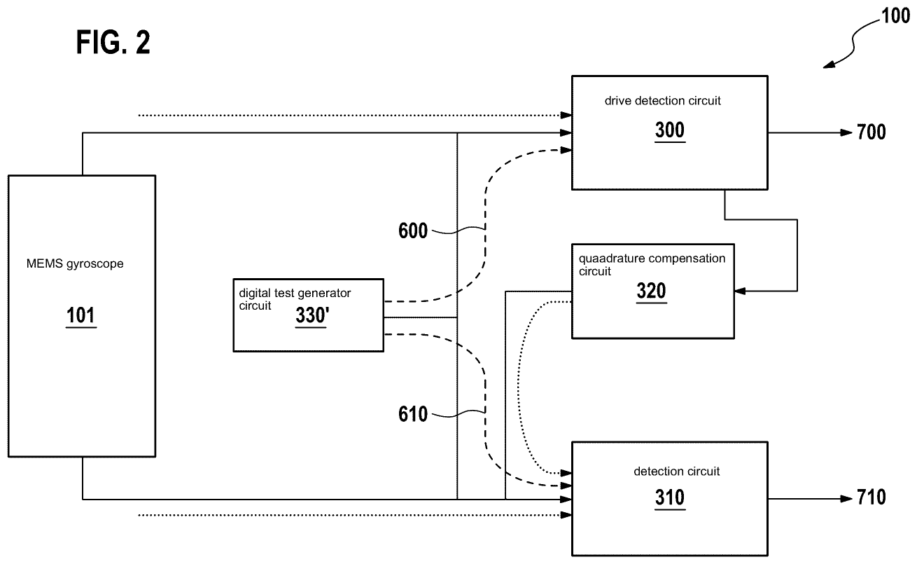

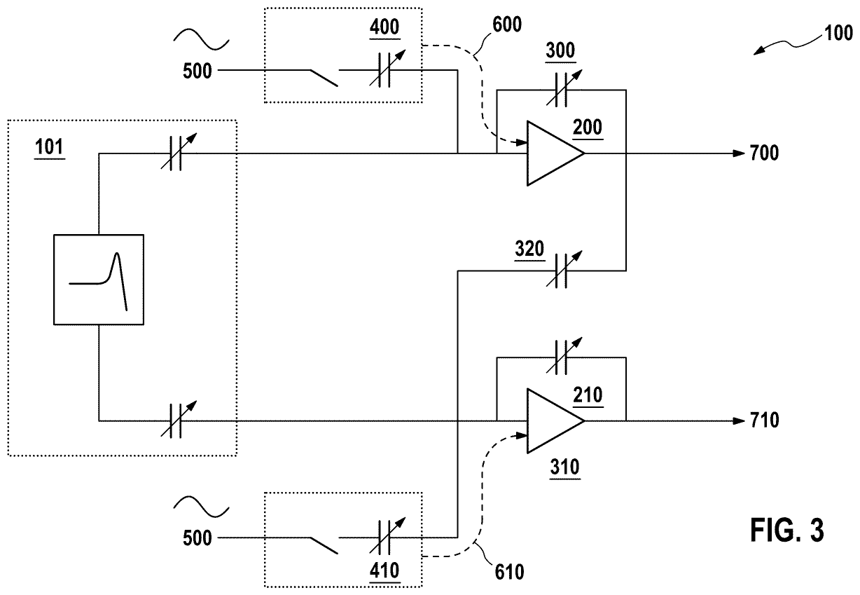

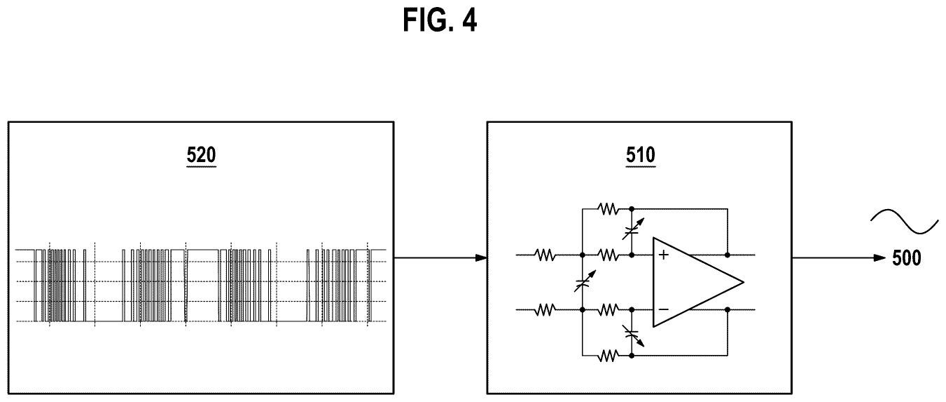

FIG. 1 shows a very schematic representation, merely for illustrating the basic principle, of a principle circuit diagram of a sensor system 100 with a MEMS gyroscope 101 without a quadrature compensation circuit 320. From the MEMS gyroscope 101, two generated signals are supplied, a first analog signal to a drive detection circuit 300 (which is configured such that the first analog signal is detected due to a movement of the oscillatable seismic element of the MEMS gyroscope 101 in a drive direction) and a second analog signal to a detection circuit 310 (which is configured such that the second analog signal is detected due to a movement of the oscillatable seismic element of the MEMS gyroscope 101 in a detection direction substantially perpendicular to the drive direction). The output of the drive detection circuit 300 is denoted by reference sign 700 and the output of the detection circuit 310 is denoted by reference sign 710. In detail, the first analog signal is supplied to the drive detection circuit 300 and the second analog signal is supplied to the detection circuit 310; this is shown schematically in FIG. 1 (as well as in FIG. 2) by means of dotted arrows. Furthermore, two test signals, a first analog test signal 600 and a second analog test signal 610, are likewise supplied to the drive detection circuit 300 and the detection circuit 310, respectively, which is schematically shown in FIG. 1 (as well as in FIG. 2) by means of dashed arrows. The first and second analog test signals 600, 610 are generated according to the present invention such that they are first generated as a digital test signal 520 within a digital test generator circuit 330′ and then converted into analog test signals by means of a suitable structure (not explicitly shown in FIG. 1, but comprising a digital-to-analog converter 510, a first switch-capacitance structure 400 and a second switch-capacitance structure 410, cf. FIGS. 3 and 4). Specifically, the first analog test signal 600 is applied to the drive detection circuit 300 and the second analog test signal 610 is applied to the detection circuit 310. Within or at the output 700 and 710 of the detection circuit 310 and of the drive detection circuit 300, a phase difference can be detected or determined due to or by means of the first analog test signal 600 and the second analog test signal 610, and these phase differences can be related to one another and to the phase of the analog test signal 500 within the test generator circuit 330′.

As a further and/or additional embodiment, the analog test signal 500 (here, however, not derived from the test generator circuit 330′) can also be derived from the drive detection circuit 300 by means of a suitable structure.

The test generator circuit 330′ is in particular realized in the form of a block, which generates a test signal (in the form of the first and second analog test signals 600, 610), which is supplied to the inputs of the ASIC signal chain. In this case, the drive detection circuit 300 or the detection circuit 310 can be operated with the first and/or second analog test signal 600, 610 applied, both with the MEMS gyroscope 101 connected and, at least during the production of the sensor system, but possibly also afterwards, for example during a calibration operating mode in the operative operation of the sensor system, if the MEMS gyroscope 101 is configured to be electrically separable from the ASIC signal chain.

FIG. 2 shows a very schematic representation of a principle circuit diagram of the sensor system 100 with a MEMS gyroscope 101 with a schematically shown quadrature compensation circuit 320. Here, the result is the same representation as in FIG. 1, but with the quadrature compensation circuit 320, which is coupled to the drive detection circuit 300 and the detection circuit 310 (in particular, the output of the quadrature compensation circuit 320 acts on the input of the detection circuit 310). The quadrature compensation circuit 320 ensures compensation for the quadrature signal component in the second analog signal and improves the signal quality of the second analog signal, which is supplied to the detection circuit 310. The output of the drive detection circuit 300 is denoted by reference sign 700 and the output of the detection circuit 310 is denoted by reference sign 710. Furthermore, within such an arrangement, a phase difference with respect to the first analog test signal 600 and the second analog test signal 610 can also be detected and can be related to the phase of the analog test signal 500 and a phase or phase delay within the quadrature compensation circuit 320 (as a result of the application of an analog compensation signal); in particular, if the first analog test signal 600 is applied to the drive detection circuit 300, this also affects the signal provided by the quadrature compensation circuit 320 (at the input of the detection circuit 310) and, thereby, also the signal detectable at the output 710 of the detection circuit 310.

Since the origin (i.e., the analog test signal 500) of the first and second test signals 600, 610 (i.e., the signals that are or can be applied to the drive detection circuit 300 (drive) and the detection circuit 310 (sense)) is the same, the phase difference between the drive signal path and the sense signal path can be measured by evaluating the two output signals.

According to the arrangement shown in FIG. 2, the quadrature is compensated by a special block (quadrature compensation circuit 320), which generates a compensation signal, which is fed into the sensor input (input of sense) from a signal generated by the drive signal path (drive). According to the present invention, the measurement of the phase (or of a phase difference) of such a quadrature compensation circuit is thus also made possible.

FIG. 3 shows a schematic circuit diagram of the sensor system 100 with the MEMS gyroscope 101 and with the quadrature compensation circuit 320 according to the present invention. As already shown in FIGS. 1 and 2, the MEMS gyroscope 101 provides the first analog signal and the second analog signal to the drive detection circuit 300 and to the detection circuit 310, respectively. The output of the drive detection circuit 300 is denoted by reference sign 700 and the output of the detection circuit 310 is denoted by reference sign 710. In detail, the first analog test signal is applied to the input of the first interface amplifier 200 and the second analog test signal is applied to the input of the second interface amplifier 210. A signal derived from the output of the first interface amplifier 200 is forwarded to the quadrature compensation circuit 320 and the derived signal is used within the quadrature compensation circuit 320 to generate a compensation signal, which is forwarded to the input of the second interface amplifier 210 within the detection circuit 310 for compensating the quadrature signal component within the second analog signal. Furthermore, the test generator circuit 330′ (not explicitly shown here) generates the analog test signal 500. The analog test signal 500 is fed into the first switch capacitance circuit 400 for generating the first analog test signal 600 and is furthermore also fed into the second switch capacitance circuit 410 for generating the second analog test signal 610. The first switch capacitance circuit 400 is connected on the output side to the input of the first interface amplifier 200 (or to the input of the drive detection circuit 300), so that the first analog test signal 600 is or can be applied thereto. Furthermore, the second switch capacitance circuit 410 is also connected on the output side to the second interface amplifier 210 (or to the input of the detection circuit 310), so that the second analog test signal 610 is or can be applied thereto. If the first analog test signal 600 is applied to the input of the first interface amplifier 200 or to the input of the drive detection circuit 300 or if the second analog test signal 610 is applied to the input of the second interface amplifier 210 or to the input of the detection circuit 310, this leads to a corresponding signal or at least to a corresponding signal component at the output of the first and/or second interface amplifier 200, 210. The phases or the phase differences of such signals or signal components can be detected and related to the phase of the analog test signal 500. Furthermore, a relationship to the phase within the quadrature compensation circuit 320 can likewise be determined. In addition to the information obtained from the detected phase differences, information about a phase delay within the quadrature compensation circuit 320 (as a result of the application of the analog compensation signal) can thus also be determined. Furthermore, it is thus also possible to obtain information about the phase delay within selected subcircuits of the detection circuit 310 and/or drive detection circuit 300. Furthermore, it is thus also possible to obtain information about the corresponding temperature range for optimal operation.

The test signal (first or second analog test signal 600, 610) is or the test signals (first and second analog test signals 600, 610) are thus generated from a common source (analog test signal 500), in order to ensure the same phase between the test signal injection at drive and sense.

Such a test signal is or such test signals are then coupled to both the drive input and the sense input via special configurable capacitances (first or second switch capacitance circuit 400, 410). These capacitances can be configured independently of one another for the drive input and for the sense input, in order to be able to select the amounts of charge to be injected at the input nodes, independently of one another.

Since the charges injected at the drive input and sense input have the same phase, the difference in the phase delay at the sense output in comparison to the drive output corresponds to the difference φCVsns−φCVrd, i.e., the difference in the phase delays or phase differences due to the detection circuit (φCVsns) and due to the drive detection circuit (φCVrd).

A further phase measurement can be carried out by using the additional quadrature compensation circuit while deactivating the charge injection at the sense input and activating the charge injection through the configurable capacitor connecting the driveCV output (i.e., the output 700 of the drive detection circuit 300) to the senseCV input (i.e., the input of the detection circuit 310). In this case, the difference in the phase delay at the sense output (i.e., the output 710 of the detection circuit 310) in comparison to the drive output (i.e., the output 700 of the drive detection circuit 300) corresponds to φCVsns+φqc, i.e., the sum of the phase differences due to the detection circuit (φCVsns) and due to the quadrature compensation (φqc).

According to the present invention, the test signals (i.e., the first and/or second analog test signal 600, 610) can also be provided without a connected MEMS gyroscope 101, e.g., in ASIC wafer level testing, for example in order to eliminate parts with abnormal behavior.

Such test signals can also be added to the signals coming from the MEMS gyroscope 101, in order to obtain information about the ASIC phase delays and compensate them accordingly. This method can also be used for monitoring, in order to ensure the correct functioning of the ASIC.

The test signal can in particular be a sine wave or another signal that is suitable for measuring the phase delay of the signal paths under investigation in each case.

Such a signal can be generated by a special block or taken directly from the forcing part of the gyroscope system (i.e., from the drive circuit for driving the oscillatable seismic element of the MEMS gyroscope). In the latter case, the phase delay of the drive circuit and its proper functioning can be measured additionally.

In gyroscope architectures with which the drive output cannot be measured directly, the difference between drive output and sense output can be ascertained by closing the phase-locked loop of the drive part and measuring only the sense output, which, in such a case, already corresponds to the difference between drive and sense.

FIG. 4 shows a block circuit diagram of the generation steps within the digital test generator circuit 330′ according to the present invention. The digital test signal 520 is generated, and it is converted into an analog test signal 500 by means of the digital-to-analog converter 510, in particular a second-order Butterworth filter. Due to the low-pass filtering property, the preferred embodiment using the second-order Butterworth filter allows the generation of a phase shift, to which the drive detection circuit 300 can be adjusted. Furthermore, it is preferably provided that the analog test signal 500 is a periodic signal, particularly preferably a sine signal.

A further and/or additional embodiment for the generation represents a suitable structure (not explicitly shown here) for deriving a suitable test signal from the drive detection circuit 300.

A circuit for generating the test signal for a system with a closed loop at the ASIC level (without connected MEMS) is shown in FIG. 4. The signal at the input of the filter is generated by a clock controlled by the phase-locked loop. The filter (e.g., second-order Butterworth) makes it possible to generate a phase shift, to which the control loop can adjust. In one implementation, the input of the filter can be generated by a digital signal.

What is claimed is:

1. A sensor system with a MEMS gyroscope, the sensor system comprising:
a drive circuit, which is configured to generate an analog drive signal for driving an oscillatable seismic element of the MEMS gyroscope and includes a first interface amplifier of a drive detection circuit, wherein the drive detection circuit is configured such that, due to a movement of the oscillatable seismic element in a drive direction, a first analog signal is detected and is supplied to an input of the first interface amplifier;
a detection circuit, which is coupled to the drive circuit and the oscillatable seismic element and includes a second interface amplifier, wherein the detection circuit is configured such that, due to a movement of the oscillatable seismic element in a detection direction substantially perpendicular to the drive direction, a second analog signal is detected and supplied to an input of the second interface amplifier, wherein the second analog signal includes an analog rotation rate signal component and an analog quadrature signal component;
a quadrature compensation circuit, which is configured with the drive detection circuit such that an analog compensation signal of the quadrature compensation circuit for compensating the analog quadrature signal component is applied to the input of the second interface amplifier; and
a digital test signal generator circuit, which is configured to apply a digital test signal to a digital-to-analog converter for conversion into an analog test signal, wherein an output of the digital-to-analog converter is connected to the input of the first interface amplifier via a first switch-capacitance structure and to the input of the second interface amplifier via a second switch-capacitance structure, wherein the analog test signal can be applied to the first interface amplifier using the first switch-capacitance structure and/or to the second interface amplifier using the second switch-capacitance structure;
wherein, using the analog test signal, a first analog test signal can be provided by the first switch-capacitance structure,
wherein, using the analog test signal, a second analog test signal can be provided by the second switch-capacitance structure,
wherein a phase difference can be detected by selectively applying the first analog test signal to the input of the first interface amplifier and/or by selectively applying the second analog test signal to the input of the second interface amplifier.

2. The sensor system according to claim 1, wherein the first switch-capacitance structure has a first variable capacitance for adjusting the application of the first analog test signal and the second switch-capacitance structure has a second variable capacitance for adjusting the application of the second analog test signal.

3. The sensor system according to claim 1, wherein the first switch-capacitance structure has a first switch configured to interrupt the application of the first analog test signal, and the second switch-capacitance structure has a second switch configured to interrupt the application of the second analog test signal.

4. The sensor system according to claim 1, wherein the analog test signal is a periodic signal.

5. The sensor system according to claim 4, wherein the analog test signal is a sine signal.

6. The sensor system according to claim 1, wherein the digital test generator circuit is configured such that the digital test signal: (i) is generated using a generation element, the generation element including a second-order Butterworth filter, and/or (ii) is derived from the drive detection circuit using a structure, including deriving from an internal time signal which is regulated to an output of the drive detection circuit.

7. A method for operating a sensor system with a MEMS gyroscope, the sensor system including:
a drive circuit, which is configured to generate an analog drive signal for driving an oscillatable seismic element of the MEMS gyroscope and includes a first interface amplifier of a drive detection circuit, wherein the drive detection circuit, due to a movement of the oscillatable seismic element in a drive direction, detects a first analog signal that is supplied to an input of the first interface amplifier,
a detection circuit, which is coupled to the drive circuit and the oscillatable seismic element and includes a second interface amplifier, wherein the detection circuit, due to a movement of the oscillatable seismic element in a detection direction substantially perpendicular to the drive direction, detects a second analog signal that is supplied to an input of the second interface amplifier, wherein the second analog signal includes an analog rotation rate signal component and an analog quadrature signal component,
a quadrature compensation circuit, a digital test signal generator circuit, and a digital-to-analog converter, wherein an output of the digital-to-analog converter is connected via a first switch-capacitance structure to the input of the first interface amplifier and via a second switch-capacitance structure to the input of the second interface amplifier;
the method comprising the following steps:
in a first method step, applying by the quadrature compensation circuit with the drive detection circuit an analog compensation signal of the quadrature compensation circuit for compensating the analog quadrature signal component to the input of the second interface amplifier;
in a second method step, applying by the digital test signal generator circuit a digital test signal to the digital-to-analog converter for conversion into an analog test signal;
wherein the analog test signal is applied to the first interface amplifier using the first switch-capacitance structure and/or to the second interface amplifier using the second switch-capacitance structure;
wherein, using the analog test signal, a first analog test signal is provided by the first switch-capacitance structure;
wherein, using the analog test signal, a second analog test signal is provided by the second switch-capacitance structure; and
wherein a phase difference is detected by selectively applying the first analog test signal and/or by selectively applying the second analog test signal to an input of the first interface amplifier and/or of the second interface amplifier in each case.
